(19) United States
(12) Patent Application Publication
(10) Pub. No.: US 2002/0143172 A1
(43) Pub. Date: Oct. 3, 2002

(54) Production of oxidized polysaccharide drivative and oxidized polyglycosamine drivative

(76) Inventors: Tadashi Ookawa, Ibaraki (JP); Satoshi Ueno, Chiba (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/058,920

(22) Filed: Jan. 30, 2002

(30) Foreign Application Priority Data
Jan. 30, 2001 (JP) 022397/2001
Oct. 2, 2001 (JP) 306877/2001

(51) Int. Cl. C08B 37/06; C08B 35/08; C08B 33/08; C08B 31/18

(52) U.S. Cl. 536/56; 536/2; 536/105

(57) ABSTRACT

In the process for producing an oxidized polysaccharide derivative of the present invention, a polysaccharide is pretreated to enhance its water solubility and then a primary alcohol group of the pretreated polysaccharide is selectively oxidized into a carboxyl group by hypochlorous acid or its salt in the presence of a nitroxyl compound. With such a process, a sufficient number of carboxyl groups can be introduced into the polysaccharide without preventing the cleavage of molecular chain, thereby producing the oxidized polysaccharide derivative having an improved water absorption. In the process for producing an oxidized polyglycosamine derivative of the present invention, a polyglycosamine is pretreated to enhance its water solubility and then a primary alcohol group of the pretreated polyglycosamine is selectively oxidized into a carboxyl group by hypochlorous acid or its salt in the presence of a nitroxyl compound. With such a process, a sufficient number of carboxyl groups can be introduced into the polyglycosamine without preventing the cleavage of molecular chain, thereby producing the oxidized polyglycosamine derivative having properties comparable to those of naturally occurring mucopolysaccharide.

### BACKGROUND OF THE INVENTION

1. Field of the Invention

The present invention relates to a process for producing an oxidized polysaccharide derivative from polysaccharide such as starch and cellulose. The present invention further relates to an oxidized polyglycosamine (polyamino sugar) derivative and a process for producing the oxidized polyglycosamine derivative from polyglycosamine such as chitin and chitosan.

2. Description of the Prior Art

Recently, various derivatives produced from natural polysaccharides and polyglycosamines have been extensively studied and used in various application fields because of their high biodegradability and high compatibility with living organism.

High water-absorbing resins have been extensively used as medical supplies such as disposable diapers and sanitary goods as well as water retention agents for soil and sealing agents in various application fields such as agricultural and horticultural fields, civil engineering and architectural fields and medical fields. As such high water-absorbing resins, in addition to a synthetic resin such as cross-linked polyacrylates, cross-linked polyvinyl alcohols and cross-linked isobutylene-maleic anhydride copolymers, a semi-synthetic resin using a natural substance as a part of raw materials, such as cross-linked starch-acrylate graft copolymers, cross-linked carboxymethyl celluloses and cross-linked acidic amino acid polymers, has been known.

Of these high water-absorbing resins, a polyacrylic acid-based resin has been more extensively used from the standpoints of high water absorptivity, low price and the like. However, it is known that the polyacrylic acid-based resin is extremely low in biodegradability. In addition, the water absorptivity of the polyacrylic acid-based resin is good with respect to ion-exchanged water, but, quite sensitive to the concentration and kind of salts. For example, it is known that the water-absorbing to a physiological saline is reduced to as low as 1/20 to ⅕ of that to ion-exchanged water.

To solve these problems, various attempts have been made. Japanese Patent Application Laid-Open No. 56-5137 discloses, as a water absorbent having an excellent salt stability, a cross-linked polysaccharide containing uronic acid or its salt and a cross-linked product of a carboxyalkylated polysaccharide containing uronic acid or its salt. As the polysaccharide, extracellular polysaccharides such as xanthan gum, a polysaccharide oxidized by nitrogen dioxide, or the like are exemplified. Japanese Patent Application Laid-Open No. 60-58443 discloses a polymer composition capable of exhibiting an excellent absorbability to body fluids, such as a high absorption polymer composition composed of a mixed gel of natural polysaccharides, a gel of carageenan and locust bean gum, a gel of carageenan and xanthan gum and a gel of xanthan gum and konjakmannan. Japanese Patent Application Laid-Open No. 8-41103 discloses a process for the production of a water-absorbing cellulose, such as a salt of a cross-linked carboxymethyl cellulose, which is excellent in the absorbability to a salt water and the gel strength. As a water-absorbing resin having an excellent absorbability to an aqueous liquid and a good biodegradability, Japanese Patent Application Laid-Open No. 8-59820 discloses a water-absorbing resin which is prepared by cross-linking an acidic polyamino acid such as polyaspartic acid with a basic polyamino acid. In Chemistry and Industry, Vol. 52, No. 5, p. 624 (1999), there is described a cross-linked γ-polyglutamic acid.

However, these high water-absorbing resins are insufficient as the substitute for polyacrylic acid-based water-absorbing resins in view of the performance and the production costs. Therefore, it has been still demanded to provide an inexpensive high water-absorbing resin which are improved in the biodegradability by microorganism and the absorbability to physiological saline.

Tetrahedron Lett. 34, 1181-1184 (1993) describes the synthesis of uronic acid by selectively oxidizing a primary alcohol group of a monosaccharide derivative in the presence of 2,2,6,6-tetramethylpiperidine-1-oxyl (TEMPO) and KBr using sodium hypochlorite as an oxidizing agent in a two-layered reaction system. Red. Trav. Chim. Pays-Bas, 113, 165-166 (1994) describes a selective oxidation of a primary alcohol group of a polysaccharide in the presence of TEMPO in which TEMPO and hypobromous acid are oxidatively regenerated by hypochlorous acid, and a primary alcohol group of a cold water-soluble potato starch and dahlia inulin is selectively oxidized into a carboxylic group. Carbohydr. Res., 269, 89-98 (1995) and WO95/07303 also describes a selective oxidation of a primary alcohol group of a water-soluble glucan or carbohydrate in an aqueous solution in the presence of TEMPO and sodium bromide using sodium hypochlorite as an oxidizing agent. These literatures and patent publication describe that the oxidation of the primary alcohol group proceeds at a high yield and high selectivity. However, the polysaccharide being oxidized suffers from the cleavage of molecular chains simultaneously with the oxidation. Further, if the use of bromine, bromide, iodine or iodide is omitted to avoid the cleavage of molecular chains, the rate of the oxidation reaction is lowered, and in some cases, the oxidation reaction does not apparently proceed. The reaction rate may be increased by raising the reaction temperature, raising the pH of the reaction, etc. However, these techniques are also likely to cause the cleavage of molecular chains.

These polysaccharide derivatives, especially those obtained by selectively oxidizing a primary alcohol group into a carboxyl group, are considered to be usable as a substitute for the polyacrylic acid-based high water-absorbing resin because the starting polysaccharides are available at low costs and the resultant derivatives are expected to show a good water absorbability in view of its structure. However, the introduction of carboxyl group or its salt form into polysaccharide by the above conventional methods cannot prevent the cleavage of molecular chains of the polysaccharide. If a larger number of carboxyl group is introduced to further enhance the water absorbability, there inevitably arises such a problem that the polysaccharide is cleaved into lower-molecular weight compounds. Thus, no water-absorbing resin comparable to the polyacrylic acid-based high water-absorbing resin has been provided.

Polyglycosamines typically exemplified by chitin and chitosan as well as various derivatives thereof contain an acetamide group and an amino group in repeating units thereof, and therefore, have drawn attention in various application fields because of their biocompatibility, bioactivity or a chelate-forming property, and practically used as raw materials of medicines, cosmetics, coagulants, etc. Chitin is a compound having a straight-chain structure of β1,4-bonded N-acetyl-D-glucosamine, and occurs abundantly in integuments of crustaceans such as crabs and lobsters or exoskeletons of insects. Chitin can be deacetylated into chitosan having a free amino group, and hardly soluble in water, diluted acid or diluted alkali. Chitosan is soluble only in an acidic solution.

Mucopolysaccharides (glycosaminoglycans) are composite polysaccharides containing glycosamine residues, which are widely distributed in the ground substances of animal connective tissues and animal body fluids. Many of the mucopolysaccharides have a straight-chain structure composed of repeating uronic acid-glycosamine disaccharide residues. Examples thereof include hyaluronic acid, chondroitin, chondroitin sulfuric acid, heparin or the like. As conventionally known, the mucopolysaccharides are useful substances exhibiting many biological functions such as anticoagulative activity, antilipemic activity, lubrication ability and water retention. Therefore, the mucopolysaccharides have been extensively studied and researched at the present time.

The mucopolysaccharides are generally expensive. For this reason, many attempts for obtaining more inexpensive analogues to mucopolysaccharides have been made in order to expand the application fields. Such attempts have been generally directed to the modification of a more inexpensive polyglycosamine because its structure is well analogous to that of the mucopolysaccharides. Japanese Patent Application Laid-open No.61-501923 discloses a process for producing an oxidized chitin as a glycosaminoglycan polymer applicable to cosmetic fields, using an oxidant such as CrO₃, NO₂ gas and a liquid dimer thereof (N₂O₄). Japanese Patent Application Laid-open No. 59-106409 discloses cosmetics containing a chitin derivative such as carboxymethylchitin. Japanese Patent Application Laid-open No. 2-105801 discloses a novel chitosan derivative, a production method thereof in which N-(3-carboxypropanoyl)-6-O-(carboxymethyl)chitosan and 6-O-(carboxymethyl)chitosan are reacted with succinic anhydride, and a use of the chitosan derivative as a humectant. Also, Japanese Patent Application Laid-open No. 2000-256404 discloses an oxidized chitosan derivative produced by oxidizing or acetylating chitosan in the presence of an oxidant such as chromic anhydride, sodium permanganate, hydrogen peroxide and sodium hypochlorite.

However, in these conventional modification methods, since the starting chitin and chitosan are sparingly soluble, a modified product having a sufficient number of functional groups introduced and having a high molecular weight has not necessarily been obtained. In the modification mainly by the oxidation, there arises a problem such as reduction of the molecular weight and occurrence of side reactions. In the modification mainly by the addition reaction, there is a problem such as uneven distribution of substituent groups and low substitution degree. For these reasons, the known derivatives fail to exhibit the intended properties sufficiently, and therefore, a modified polyglycosamine as a more inexpensive analogue to mucopolysaccharides has been still demanded.

When a polyglycosamine is oxidized by the method described in Carbohydr. Res., 269, 89-98 (1995) and WO95/07303 referred to above, the similar problems to those mentioned above arise. J. Carbohydrate Chem., 15, 819-830 (1996) describes a similar oxidation method using a water-insoluble polyglycosamine such as chitin and chitosan as a substrate. However, the oxidation yield of chitin is as low as about 40%. The document teaches that the oxidation yield of chitosan is high, but the viscosity is extremely reduced. This strongly suggests the reduction of the molecular weight, i.e., the occurrence of cleavage of molecular chain. Further, Cellulose, 5, 153-164 (1998) describes a similar oxidation method using chitin, chitosan, etc., as a substrate. Although the oxidation of chitin proceeds somewhat selectively, the document indicates that the molecular weight is usually reduced. It is also reported that a considerable depolymerization undergoes in the oxidation of chitosan.

### SUMMARY OF THE INVENTION

A first object of the present invention is to provide a process for producing, from polysaccharide, an oxidized polysaccharide derivative capable of providing an inexpensive high water-absorbing resin having an improved biodegradability by microorganism and absorbability to physiological saline.

A second object of the present invention is to provide a more inexpensive analogue of mucopolysaccharides, more specifically, to provide an oxidized high-molecular polyglycosamine derivative having a sufficient number of carboxyl groups introduced and showing functions comparable with those of mucop olysaccharides.

A third object of the present invention is to provide a process for the production of the oxidized polyglycosamine derivative.

As a result of extensive researches in view of the above objects, the inventors have found that a sufficient number of carboxylic groups can be introduced into a polysaccharide or a polyglycosamine without causing a cleavage of the molecular chain thereof by pre-treating the polysaccharide or the polyglycosamine to enhance its water solubility and then oxidizing the treated polysaccharide or polyglycosamine with hypochlorous acid or its salt in the presence of a nitroxyl compound, thereby obtaining an oxidized polysaccharide derivative having an improved water absorbability or an oxidized polyglycosamine having functions comparable to mucopolysaccharide. The present invention has been accomplished based on this finding.

Thus, in a first aspect of the present invention, there is provided a process for producing an oxidized polysaccharide derivative, comprising (1) pretreating a polysaccharide to enhance a water solubility thereof; and (2) oxidizing the pretreated polysaccharide with hypochlorous acid or a salt thereof in the presence of a nitroxyl compound.

In a second aspect of the present invention, there is provided a high water-absorbing resin comprising the above oxidized polysaccharide derivative having a weight-average molecular weight of 200,000 or more.

In a third aspect of the present invention, there is provided a process for producing an oxidized polyglycosamine derivative, comprising (1) pretreating a polyglycosamine to enhance a water solubility thereof; and (2) oxidizing the pretreated polyglycosamine with hypochlorous acid or a salt thereof in the presence of a nitroxyl compound.

In a fourth aspect of the present invention, there is provided an oxidized polyglycosamine derivative having a molecular weight of 100,000 or more, in which 40% or more of primary alcohol groups of repeating units are oxidized into carboxyl groups.

### DETAILED DESCRIPTION OF THE INVENTION

The polysaccharide used in the present invention may include α-bonded polysaccharides such as starch, amylose, amylopectin, pectin, protopectin, pectic acid and derivatives thereof, and β-bonded polysaccharides such as cellulose and derivatives thereof. Of these polysaccharides, starch and its constituents such as amylose and amylopectin and derivatives thereof are preferred in view of easiness of reaction and availability. Examples of starch include corn starch, tapioca starch, potato starch, wheat starch, sweet potato starch, rice starch and waxy corn starch. In order to ensure a high molecular weight for a polysaccharide derivative after the oxidation reaction, it should be avoided to subject the polysaccharide to a pretreatment which physically or chemically reduces the molecular weight or a pretreatment which promotes the cleavage of the molecular chain during the oxidation, or to use a polysaccharide containing impurities which promote the cleavage of the molecular chain during the oxidation. The concentration of the polysaccharide in the reaction solution is 0.1 to 80% by weight, preferably 1 to 50% by weight.

In the present invention, the term “polysaccharide” means a polysaccharide which is gelatinizable by the methods described below, and includes starch, amylose, amylopectin, pectin, protopectin, pectic acid, cellulose, derivatives thereof, etc., but not include the polyglycosamine such as chitin and chitosan mentioned below.

In the process of the present invention, the polysaccharide pretreated to enhance a water solubility is used as a starting material in order to proceed the oxidation reaction while preventing the cleavage of molecular chain. Therefore, the pretreatment for enhancing the water solubility is needed not to cause so much cleavage of molecular chain. The pretreatment for enhancing the water solubility is effected, for example, by a gelatinization of α-bonded polysaccharide, a mercerization of β-bonded polysaccharide, a carboxyalkylation or hydroxyalkylation of a hydroxyl group of polysaccharide, etc. The pretreated polysaccharide may be subjected to the subsequent oxidation after drying or immediately after the pretreatment. The pretreatment allows the polysaccharide to be freely hydrated with water which is used as a reaction solvent, resulting in facilitation of the oxidation reaction with the cleavage of molecular chain prevented.

The gelatinization of α-bonded polysaccharide may be carried out by heating the polysaccharide in the presence of water or by immersing the polysaccharide in a medium capable of breaking hydrogen bond, such as dimethyl sulfoxide, dimethylformamide, liquid ammonia, an alkali solution and a sodium rhodanate solution. Taking into account the prevention of the cleavage of molecular chain and the treatment costs, the gelatinization under heating is preferable. The heat-gelatinization conditions such as concentration of polysaccharide in water suspension, temperature, pH and time vary depending upon kinds of the polysaccharides used, and may be determined so as to effectively inhibit the cleavage of molecular chains. Although the gelatinization initiation temperature of various starches is usually about 60 to about 80° C., it is known that the gelatinization initiation temperature is different from particle to particle of starches by about 10° C. Therefore, the gelatinization is preferably performed by heating a water suspension of polysaccharide particles at a suitable temperature determined on the basis of the gelatinization initiation temperature. Generally, the gelatinization of α-bonded polysaccharide may be carried out by heating a water dispersion having a concentration of 1 to 50% by weight at 60 to 95° C. for 0.1 to 120 min.

The mercerization, carboxyalkylation or hydroxyalkylation may be carried out in a manner known in the art.

The polyglycosamine usable in the present invention comprises repeating monosaccharide residues in which alcoholic hydroxy groups are substituted by amino groups or N-substituted amino groups such as acetamido groups, and may include derivatives thereof. Simple polysaccharides constituted only by amino sugar residues or derivatives thereof, and complex polysaccharides constituted by a plural kinds of amino sugar residues and another sugar residues or derivatives thereof are also usable in the present invention. The sugar residues of the polyglycosamine may be bonded by either α-linkage or β-linkage. Examples of the polyglycosamine and derivatives thereof include polyglucosamines such as chitin and chitosan, mucopolysaccharides such as polygalactosamine, hyaluronic acid, chondroitin and chondroitin sulfate, and derivatives thereof, as well as polysaccharides produced by microorganisms having a similar structure and polysaccharides obtained by introducing amino groups into amino-free polysaccharides such as starch and cellulose. Of these, chitin, chitosan, derivatives thereof, and polygalactosamines are preferred in view of low cost and availability. In order to ensure a high molecular weight for a polyglycosamine derivative after the oxidation reaction, it should be avoided to subject the polyglycosamine to a pretreatment which physically or chemically reduces the molecular weight or a pretreatment which promotes the cleavage of the molecular chain during the oxidation, or to use a polyglycosamine containing impurities which promote the cleavage of the molecular chain during the oxidation.

In the process of the present invention, in order to oxidize a polyglycosamine without cleavage of molecular chain, the starting polyglycosamine is pretreated for enhancing a water solubility. As the pretreatment for enhancing a water solubility, there may be used a method of treating the polyglycosamine with ethylene oxide or propylene oxide, a method of carboxymethylaing or succinylating the polyglycosamine, or the like. Preferred is a pretreatment in which the water solubility of the polyglycosamine is enhanced by controlling the acetylation degree of amino groups. Most of naturally occurring polyglycosamines are N-acetylated. Therefore, when treated with a concentrated alkali solution, the N-acetylated amino groups are deacetylated into free amino groups. The acetylation degree of the polyglycosamine may be controlled by such a deacetylation or a partial acetylation of free amino groups of the polyglycosamine.

Examples of alkali used for the deacetylation include alkali metal hydroxides such as sodium hydroxide, potassium hydroxide and lithium hydroxide; alkaline earth metal hydroxides such as barium hydroxide and calcium hydroxide; and alkali metal carbonates such as sodium carbonate and potassium carbonate with sodium hydroxide and potassium hydroxide being preferred. The concentration of the alkali solution is 10% by weight or higher, preferably 40% by weight or higher. When N-acetylpolyglycosamine is immersed in an alkali solution for deacetylation, the deacetylation temperature is maintained at 50° C. or lower. For the purposes of preventing the cleavage of molecular chains or enhancing the water solubility, the deacetylation temperature is preferably maintained at 30° C. or lower, more preferably 5° C. or lower. The immersion of the N-acetylpolyglycosamine in the alkali solution may be carried out more effectively by dispersing the N-acetylpolyglycosamine in the alkali solution and then stirring the resulting dispersion under reduced pressure. After the N-acetylpolyglycosamine is sufficiently immersed in the alkali solution, ice or water is added to the alkali solution to reduce the concentration thereof to 5 to 25% by weight. Then, the resulting solution is aged for one-hour to one week to proceed the deacetylation, followed by neutralization with an acid such as hydrochloric acid and acetic acid. During the neutralization, the temperature is preferably maintained at 30° C. or lower, more preferably 5° C. or lower. Although the neutralization is accompanied by the gelation of the solution, the solution is added, if required, to an excess amount of cold water-containing acetone to cause precipitation. The resulting gels or precipitates are recovered from the solution by solid-liquid separation procedure such as filtration and centrifugation, thoroughly washed with a water-soluble organic solvent such as water-containing acetone, methanol and ethanol, and then, dried to obtain a deacetylated product. The deacetylation degree varies depending upon the alkali concentration, the substrate concentration, the deacetylation temperature, the deacetylation time, etc. Alternatively, the deacetylated product may be produced by another method, e.g., by using a deacetylating enzyme.

The partial acetylation of the free amino-containing polyglycosamine may be performed by adding acetic anhydride thereto under ice-cooling. Preferred is a free amino-containing polyglycosamine having a deacetylation degree close to 1.0 and being soluble in an acid solution.

In the partial acetylation, the free amino-containing polyglycosamine is first dissolved in an acid solution. Examples of the acid are organic acids such as acetic acid and formic acid, and inorganic acids such as hydrochloric acid and nitric acid with acetic acid and hydrochloric acid being preferred. The concentration of the acid is preferably in the range of 1 to 15%. The resulting solution is diluted with a water-soluble organic solvent such as methanol and ethanol, and then, dropped into ice-cooled pyridine to obtain a highly swelled gel. The gel is recovered by solid-liquid separation procedure such as filtration and centrifugation, deflocculated, washed with pyridine, and then dispersed again in pyridine. The acetic anhydride may be added either immediately after the dissolution of the free amino-containing polyglycosamine into the acid solution, after the dilution with the water-soluble organic solvent or after the gelation. Alternatively, the acetic anhydride may be added in advance to pyridine before the gelation. This renders the procedure after the addition of acetic anhydride unnecessary. The addition amount of acetic anhydride is preferably 2 to 20 mol per one mole of the free amino group. If necessary, the reaction mixture may be aged for promoting the acetylation, and then, added to an excess amount of cold water-containing acetone to cause precipitation. The resulting gels or precipitates are recovered by solid-liquid separation procedure such as filtration and centrifugation, sufficiently washed with a water-soluble organic solvent such as water-containing acetone, methanol and ethanol, and then dried to obtain a partially acetylated product.

When O-acetylation occurs together with the N-acetylation, the resulting O-acetyl group should be partially hydrolyzed. The hydrolysis of the O-acetyl group is effectively conducted by stirring in an alcohol solution of alkali. Examples of the alkali are sodium hydroxide and potassium hydroxide. Examples of the alcohol are methanol and ethanol. The resulting gels or precipitates are recovered by solid-liquid separation procedure such as filtration and centrifugation, sufficiently washed with a water-soluble organic solvent such as water-containing acetone, methanol and ethanol, and then, dried to obtain a partially N-acetylated product.

The acetylation degree varies depending upon the amount of acetic anhydride used, the timing for adding acetic anhydride, the concentration of substrate, temperature, time, etc.

From the standpoints of enhancing the water solubility and obtaining an analogue of mucopolysaccharides, the acetylation degree is preferably 0.3 or higher, more preferably 0.4 to 0.8. The acetylation degree is a ratio of the number of the N-acetylamino groups in the repeating units to the total number of the N-acetylamino groups and the free amino groups, and may be calculated from the nitrogen content and the carbon content obtained by elemental analysis or the ratio of the amide absorption I at 1655 cm⁻¹ to the hydroxyl absorption at 3450 cm⁻¹ by IR method.

The pretreated polysaccharide or polyglycosamine is then oxidized in the presence of the nitroxyl compound with the cleavage of molecular chain prevented.

As the oxidizing agent, hypochlorous acid and a hypochlorite such as sodium hypochlorite, potassium hypochlorite and calcium hypochlorite may be used.

The nitroxyl compound may include N-oxides of hindered amines, preferably N-oxides of hindered amines having a bulky group at α-position of amino group or imino group, and more preferably di-tert-alkylnitroxyl compounds. Example of the di-tert-alkylnitroxyl compounds is tetraalkylpiperidine-1-oxyl such as 2,2,6,6-tetraalkylpiperidine-1-oxyl, 4-hydroxy-2,2,6,6-tetraalkylpiperidine-1-oxyl and 4-alkoxy-2,2,6,6-tetraalkylpiperidine-1-oxyl. Of these di-tert-alkylnitroxyl compounds, preferred are 2,2,6,6-tetramethylpiperidine-1-oxyl, 4-hydroxy-2,2,6,6-tetramethylpiperidine-1-oxyl and 4-methoxy-2,2,6,6-tetramethylpiperidine-1-oxyl, and more preferred is 2,2,6,6-tetramethylpiperidine-1-oxyl (TEMPO).

In order to perform the oxidation reaction while preventing the cleavage of molecular chains, the oxidizing agent is used in an amount of 0.1 to 2.0 equivalents per unit weight of the glucopyranose and/or glucofuranose unit constituting the polysaccharide or the polyglycosamine, the reaction temperature is maintained at −5 to 50° C., and the pH of the reaction system is controlled to 7 to 11. The oxidation is carried out more preferably using the oxidizing agent 1.0 equivalent or more at pH of 8 to 10, and particularly preferably using the oxidizing agent 1.6 equivalents or more at pH of 8 to 9. An amount of the oxidizing agent exceeding 2.0 equivalents, a reaction temperature exceeding 50° C. or a pH exceeding 11 is undesirable because the cleavage of molecular chains occurs. The oxidation reaction does not proceed sufficiently when the amount of the oxidizing agent is less than 0.1 equivalent, the reaction temperature is lower than −5° C. or the pH is lower than 7. Also, from the standpoint of preventing the cleavage of molecular chains during the oxidation, bromine, bromide, iodine or iodide is used in an amount of less than 40 mol %, preferably less than 20 mol %, more preferably 1 mol % of glucopyranose and/or glucofuranose unit. Most preferably, neither bromine, bromide, iodine nor iodide is present within the reaction system.

The oxidized polysaccharide derivative of the present invention is a polysaccharide obtained by selectively oxidizing a primary alcohol group into a carboxyl group, and contains the carboxyl group in a proportion of 5 to 100 mol % per one glucopyranose or glucofuranose unit constituting the polysaccharide. The solubility of the oxidized polysaccharide derivative to water or aqueous solution varies depending upon the oxidation degree and the molecular weight. When the solubility to water or aqueous solution is low because of a low oxidation degree and a large molecular weight, and therefore, the oxidized polysaccharide derivative is gelled by absorbing water or aqueous solution but not dissolved therein, it is not necessarily required to cross-link the oxidized polysaccharide derivative. The oxidized polysaccharide derivative may be cross-linked, if required, to ensure a good gel strength and a high absorption velocity. On the contrary, if the oxidized polysaccharide derivative is highly soluble to water or aqueous solution, and therefore, dissolved by absorbing water or aqueous solution, the oxidized polysaccharide derivative should be cross-linked at least to such an extent that the derivative is insolubilized.

The method for cross-linking the oxidized polysaccharide derivative may be appropriately selected, according to requirements, from various physical or chemical methods such as a self-cross-linking by heating and a heating in the presence of a cross-linking agent. Examples of the cross-linking agent include polyamines such as ethylenediamine, hexamethylenediamine and diethylenetriamine; polyhydric alcohols such as diethylene glycol, polyethylene glycol, glycerin and sorbitol; aldehydes such as formaldehyde and glyoxal; N-methylol compounds such as dimethylol urea, dimethylol ethylene urea and dimethylol imidazolidone; polybasic acids such as oxalic acid, maleic acid and phthalic acid; acid anhydrides such as maleic anhydride and phthalic anhydride; multifunctional epoxy compounds such as ethylene glycol diglycidyl ether, polyethylene glycol diglycidyl ether and triglycidyl isocyanurate; divinyl compounds such as divinyl sulfone and methylene-bis-acrylamide; multifunctional halogen compounds such as dichloroacetone, dichloropropanol and dichloroacetic acid; halohydrin compounds such as epichlorohydrin and epibromohydrin; multifunctional isocyanates such as ethylene diisocyanate and 2,4-tolylene diisocyanate; multifunctional aziridine compounds such as tris-2,4,6-(1-aziridinyl)-1,3,5-triazine; or the like. The cross-linking agent may be added to an aqueous solution of the oxidized polysaccharide derivative so that the cross-linking agent acts on the oxidized polysaccharide derivative uniformly. Alternatively, a solution of the cross-linking agent in an organic solvent such as alcohol and ketone may be applied onto the oxidized polysaccharide derivative in the form of solid, gel or slurry, thereby allowing the cross-linking agent to act on the oxidized polysaccharide derivative from its surface.

The high water absorption of the high water-absorbing resin derived from the oxidized polysaccharide derivative of the present invention is considered to be due to its high molecular weight. To exhibit a good water absorption by gelation upon absorbing water without dissolved into water, the oxidized polysaccharide derivative is required to have a predetermined or higher molecular weight. The molecular weight of the oxidized polysaccharide derivative is distributed. The weight-average molecular weight of the oxidized polysaccharide derivative is 200,000 or higher, preferably 500,000 or higher, more preferably 1,000,000 or higher.

The oxidized polysaccharide derivative of the present invention shows an improved biodegradability by microorganism due to its chemical structure. Also, the oxidized polysaccharide derivative shows an improved absorption of physiological saline which is as high as about ¼ to ⅓ time the absorption of ion-exchanged water when evaluated by a tea-bag method. It has been confirmed that the water absorption of the oxidized polysaccharide derivative is in the same level as that of a polyacrylic acid-based high water-absorbing resin sampled from commercially available infant disposable diapers.

The oxidized polyglycosamine derivative of the present invention is a polyglycosamine obtained by selectively oxidizing a primary alcohol group into a carboxyl group, and contains the carboxyl group in an amount of 5 to 100 mol % per one glucopyranose or glucofuranose constituting unit. From the standpoints of improving the water solubility and obtaining an analogue of mucopolysaccharides, the carboxyl group content is preferably 40 mol % or more, more preferably 75 mol % or more, most preferably 90 mol % or more per one glucopyranose or glucofuranose constituting unit.

The molecular weight of the oxidized polyglycosamine derivative is an important factor for exhibiting properties comparable to those of mucopolysaccharides. For example, as known, naturally occurring hyaluronic acid is a high-molecular weight compound having a molecular weight of 1×10⁶ to 3×10⁶. The molecular weight of the oxidized polyglycosamine derivative is distributed. The weight-average molecular weight of the oxidized polyglycosamine derivative is 100,000 or higher, preferably 500,000 or higher, more preferably 1,000,000 or higher.

The oxidized polyglycosamine derivative of the present invention is an analogue of mucopolysaccharides, and exhibits various properties comparable to those of mucopolysaccharides. Upon comparing with naturally occurring hyaluronic acid which is excellent in the water absorption and moisture retention, it has been confirmed that the oxidized polyglycosamine derivative is functionally equivalent to hyaluronic acid. Namely, the oxidized polyglycosamine derivative of the present invention is a more inexpensive analogue of the naturally occurring mucopolysaccharides, and is suitably used as raw materials of cosmetics or medicines.

The present invention will be described in more detail by reference to the following examples. In the examples, properties were determined as follows.

(1) Molecular Weight

The weight-average molecular weight was measured by a size exclusion chromatography (SEC) under the following conditions using pullulan standard to calibrate the measured results. The calibration curve was prepared using pullulan having a molecular weight of up to 1.6×10⁶, and extrapolated to 1.0×10⁷ which is an exclusion limit of a separation column.

Separation column: Shodex OHpak SB-806MHQ+SB-802.5HQ

Column temperature: 40° C.

Eluent: 0.10M NaCl+0.06M Na₂HPO₄+0.04M KH₂PO₄

Flow rate: 0.8 mL/min

Injection amount: about 1.0 W/V % 10 μl

Detector: RI

(2) Water Absorption

The water absorption was measured by a so-called tea bag method.

A commercially available tea bag was filled with 0.2 to 0.5 g of a oxidized polysaccharide derivative preliminarily dried and weighed, and then immersed in an excess amount of ion-exchanged water or a physiological saline for 2 h. Then, the tea bag was taken out of water, and after draining off the water, its weight was measured. The water absorption per a unit weight of the oxidized polysaccharide derivative was calculated from the following equation:

Water absorption factor=(S−B−A)/A

S: total weight (g) of the oxidized polysaccharide derivative and the tea bag after immersed in water.

B: weight (g) of the tea bag solely after immersed in water.

A: weight (g) of the oxidized polysaccharide derivative before immersed in water.

(3) Carboxyl Group Content

The carboxyl group content of the oxidized polysaccharide derivative or the oxidized polyglycosamine derivative was measured by the NMR method. After dissolving the oxidized polysaccharide derivative or the oxidized polyglycosamine derivative in heavy water, the resulting solution was subjected to ¹³C-NMR measurement to detect a peak attributable to a methylene carbon of primary alcohol at a chemical shift of near 60 ppm, and a peak attributable to a quaternary carbon of the carboxyl group at a chemical shift of near 180 ppm. Then, a peak area ratio between the detected peaks was calculated.

(4) Acetylation Degree

The acetylation degree was determined by IR method according to the following equation using the absorbance ratio of amide absorption I at 1655 cm⁻¹ to hydroxyl absorption at 3450 cm⁻¹ and a correlation coefficient of N-acetyl group content. Meanwhile, the ester absorption attributable to O-acetyl group was observed at around 1750 cm⁻¹.

N-acetylation degree=(A₁₆₅₅/A₃₄₅₀)/1.33

A₁₆₅₅: absorbance at 1655 cm⁻¹

A₃₄₅₀: absorbance at 3450 cm⁻¹

(5) Moisture Absorption/Retention

The moisture absorption and the moisture retention were evaluated as follows. A dried powdery sample was allowed to stand in a desiccator of a constant temperature of 25° C. and a relative humidity of 81% controlled by a saturated aqueous ammonium sulfate solution to measure the change of weight with time. The moisture absorption was evaluated by the moisture absorption factor calculated by the following equation. Further, after adding a predetermined amount of water to a dried powdery sample, the sample was allowed to stand in a silica gel desiccator maintained at a constant temperature of 25° C. to measure the change of weight with time. The residual water content of the sample was calculated from the following equation to evaluate a moisture retention property.

Moisture absorption factor(%)=(W−S)/S×100

Residual water content(%)=(W−S)/H×100

S: weight (g) of the dried sample

W: weight (g) of the sample after allowed to stand in the desiccator

H: weight (g) of water added.

### EXAMPLE 1

Into a 500-mL round bottom Pyrex flask equipped with a stirrer, a thermometer, a pH electrode and feed pipes for sodium hypochlorite and sodium hydroxide, were charged 9.26 g (dried weight: 8.10 g) of corn starch available from Shikishima Starch Co., Ltd. and 72 mL of water. The mixture was suspended by stirring. The flask was immersed in a hot water bath to heat the starch at 80° C. for 15 min for gelatinization.

Thereafter, the gelatinized product was mixed with 100 mL of water and allowed to stand for cooling to near room temperature. Then the flask was immersed in a common salt-ice bath to cool the product to 2° C. Immediately after reaching 2° C., 200 mg of 2,2,6,6-tetramethylpiperidine-1-oxyl (TEMPO) was added and suspended by stirring. Then, 52.04 g of a 13.6% sodium hypochlorite (95 mmol, 1.9 equivalents per unit weight of glucopyranose unit) was added dropwise into the suspension over 60 min while carefully monitoring the increase in pH at the initial stage of the reaction. During the oxidation reaction, a 2N sodium hydroxide solution was also added dropwise into the suspension under sufficient stirring to maintain the pH at 9.0 and the temperature at 2° C. After three hours, the consumption of sodium hydroxide due to the decrease of pH was no longer caused and the reaction was terminated. The amount of sodium hydroxide consumed was 41 mmol.

The reaction solution was added dropwise into twice as much methanol as the reaction solution by volume to cause precipitation. The precipitates were collected by filtration, washed, recovered and then vacuum-dried at 50° C. overnight to obtain 11.0 g of white solid matter. The solid matter was dissolved in water, purified by dialysis, evaporated to dryness at 50° C. using a rotary evaporator, and then vacuum-dried at 50° C. overnight to obtain a film-like solid. The pullulan-calibrated weight-average molecular weight of the film-like solid determined by SEC was 900,000.

Further, the film-like solid was dissolved in heavy water under heating, and the resulting solution was subjected to ¹³C-NMR spectra measurement. As a result, it was confirmed that no peak attributable to methylene adjacent to the unreacted primary alcohol group was observed, while one peak attributable to the carbon of carboxyl group was observed together with five different peaks. This showed that the primary alcohol group at 6-position of monosaccharide residue was selectively oxidized to carboxyl group.

Then, 0.50 g of the film-like solid was placed in a commercially available tea bag and subjected to the above tea bag test to determine the water absorption factor by calculating from the measured water absorption. As a result, it was confirmed that the water absorption factor was 140 for ion-exchanged water and 45 for physiological saline.

### EXAMPLE 2

The same heat-gelatinization as in Example 1 was repeated using the same apparatus as used in Example 1. Then, the oxidation reaction was conducted in the same manner as in Example 1 except that the pH of the oxidation reaction was changed to 9.5. The amount of sodium hydroxide consumed was 42.3 mmol. Further, the same precipitation operation as in Example 1 was repeated to obtain 10.9 g of white solid matter. As a result of repeating the same dialysis-purification and evaluation as in Example 1, it was confirmed that the weight average molecular weight calibrated by pullulan standard was 800,000 and the primary alcohol group at 6-position of monosaccharide residue was selectively oxidized into carboxyl group. Then, 0.50 g of the solid matter was placed in a commercially available tea bag and subjected to the tea bag test to determine the water absorption factor by calculation from the water absorption. The water absorption factor was 110 for ion-exchanged water and 34 for physiological saline.

### EXAMPLE 3

Into a 300-mL round bottom Pyrex flask equipped with a stirrer, a thermometer, a pH electrode and feed pipes for sodium hypochlorite and sodium hydroxide, were charged 4.05 g of tapioca starch which had been previously vacuum-dried at 50° C. overnight and 36 mL of water. The resulting mixture was suspended by stirring. The flask was immersed in a hot water bath to gelatinize the starch by heating at 80° C. for 5 min.

Thereafter, the gelatinized product was mixed with 114 mL of water and allowed to stand for cooling to near room temperature, and then the flask was immersed in an common salt-ice bath to cool the contents to 2° C.

Immediately after reaching 2° C., 100 mg of TEMPO was added. Then, 26.02 g of a 13.6% sodium hypochlorite solution (47.5 mmol; 1.9 equivalents per unit weight of glucopyranose unit) was added dropwise into the suspension over 45 min and the reaction was continued for 4 h while maintaining the pH at 9.0 and temperature at 2° C. in the same manner as in Example 1. The amount of sodium hydroxide consumed was 20.5 mmol.

The precipitation operation was conducted in the same manner as in Example 1 to obtain 5.26 g of white solid matter, which was then purified by dialysis and evaluated in the same manner as in Example 1. It was confirmed that the weight-average molecular weight calibrated by pullulan standard was 1,000,000 and the primary alcohol group at 6-position of monosaccharide residue was selectively oxidized into carboxyl group.

Then, the cross-linking reaction was performed as follows. The solid matter (2.00 g) was dissolved in 100 mL of ion-exchanged water by heating to 40° C. The resulting solution was mixed with 2.0 mg of ethylene glycol diglycidyl ether and heated at 50° C. for 2 h while stirring. Then, the mixture was evaporated to dryness using an evaporator and vacuum-dried at 50° C. overnight to obtain a film-like solid. The water absorption factor of the film-like solid determined in the same manner as in Example 1 was 200 for ion-exchanged water and 70 for physiological saline.

### EXAMPLE 4

Into a 300-mL round bottom Pyrex flask equipped with a stirrer, a thermometer, a pH electrode and feed pipes for sodium hypochlorite and sodium hydroxide, were charged 4.96 g of potato starch and 36 mL of water. The resulting mixture was suspended by stirring. The flask was immersed in a hot water bath to gelatinize the starch by heating at 80° C. for 5 min.

Thereafter, the gelatinized product was mixed with 114 mL of water and allowed to stand for cooling to near room temperature, and then the flask was immersed in a common salt-ice bath to cool the product to 2° C. Immediately after reaching 2° C., 100 mg of TEMPO was added. Then, 26.02 g of a 13.6% sodium hypochlorite solution (47.5 mmol; 1.9 equivalents per unit weight of glucopyranose unit) was added dropwise over 50 min, and the reaction was continued for 4 h while maintaining the pH at 9.0 and temperature at 2° C. in the same manner as in Example 1. The amount of sodium hydroxide consumed was 20.4 mmol.

The precipitation operation was conducted in the same manner as in Example 1 to obtain 4.98 g of white solid matter, which was then purified by dialysis and evaluated in the same manner as in Example 1. It was confirmed that the weight-average molecular weight calibrated by pullulan standard was 350,000, and the primary alcohol group at 6-position of monosaccharide residue was selectively oxidized into carboxyl group.

Then, the white solid matter was mixed with ethylene glycol diglycidyl ether in an amount of 0.5% of the white solid matter, and the mixture was subjected to cross-linking reaction in the same manner as in Example 3 to obtain a solid matter. The water absorption factor of the solid matter determined in the same manner as in Example 1 was 170 for ion-exchanged water and 45 for physiological saline.

### EXAMPLE 5

The same heat-gelatinization as in Example 1 was repeated using the same apparatus as used in Example 1. Then, the oxidation reaction was conducted in the same manner as in Example 1 except that the temperature was changed to 20° C. The oxidation reaction was completed after 90 min, and the amount of sodium hydroxide consumed was 42.4 mmol. Following the same precipitation operation as in Example 1, 10.0 g of white solid matter was obtained. As a result of the same dialysis-purification and evaluation as in Example 1, it was confirmed that the weight average molecular weight calibrated by pullulan standard was 220,000, and the primary alcohol group at 6-position of monosaccharide residue was selectively oxidized into carboxyl group.

Then, the white solid matter was mixed with ethylene glycol diglycidyl ether in an amount of 1.5% of the white solid matter, and the mixture was subjected to cross-linking reaction in the same manner as in Example 3 to obtain a solid matter. The water absorption factor of the solid matter determined in the same manner as in Example 1 was 75 for ion-exchanged water and 25 for physiological saline.

### EXAMPLE 6

The same heat-gelatinization as in Example 1 was repeated using the same apparatus as used in Example 1. Then, the oxidation reaction was conducted in the same manner as in Example 1 except that only the pH was changed to 10.0. The amount of sodium hydroxide consumed was 44.3 mmol. Following the same precipitation operation as in Example 1, 10.3 g of white solid matter was obtained. As a result of the same dialysis-purification and evaluation as in Example 1, it was confirmed that the weight average molecular weight calibrated by pullulan standard was 220,000, and the primary alcohol group at 6-position of monosaccharide residue was selectively oxidized into carboxyl group.

Then, the white solid matter was mixed with ethylene glycol diglycidyl ether in an amount of 1.5% of the white solid matter, and the mixture was subjected to cross-linking reaction in the same manner as in Example 3 to obtain a solid matter. The water absorption factor of the solid matter determined in the same manner as in Example 1 was 60 for ion-exchanged water and 20 for physiological saline.

### EXAMPLE 7

The same heat-gelatinization as in Example 1 was repeated using the same apparatus as used in Example 1. Then, the oxidation reaction was conducted in the same manner as in Example 1 except for changing the amount of TEMPO to 200 mg and further adding 50 mg of NaBr (0.49 mmol; 0.97 mol % per one glucopyranose unit). The oxidation reaction was completed after 3 h, and the amount of sodium hydroxide consumed was 49.4 mmol. Following the same precipitation operation as in Example 1, 10.0 g of white solid matter was obtained. As a result of the same dialysis-purification and evaluation as in Example 1, it was confirmed that the weight average molecular weight calibrated by pullulan standard was 1,200,000, and the primary alcohol group at 6-position of monosaccharide residue was selectively oxidized into carboxyl group. The water absorption factor of the solid matter determined in the same manner as in Example 1 was 160 for ion-exchanged water and 40 for physiological saline.

Then, the white solid matter was mixed with ethylene glycol diglycidyl ether in an amount of 0.5% of the white solid matter, and the mixture was subjected to cross-linking reaction in the same manner as in Example 3 to obtain a solid matter. The water absorption factor of the solid matter determined in the same manner as in Example 1 was 140 for ion-exchanged water and 30 for physiological saline.

### Comparative Example 1

Into a 500-mL round bottom Pyrex flask equipped with a stirrer, a thermometer, a pH electrode and feed pipes for sodium hypochlorite and sodium hydroxide, were charged 9.26 g (dried weight: 8.10 g) of corn starch available from Shikishima Starch Co., Ltd. and 170 mL of water. The mixture was suspended by stirring.

The flask was immersed in a common salt-ice bath to cool to 2° C. without subjecting the starch to heat-gelatinization. Immediately after reaching 2° C., the mixture was mixed with 2.0 g of sodium bromide and 200 mg of TEMPO. Then, 56.80 g of a 13.1% sodium hypochlorite solution (100 mmol; 2.0 equivalents per unit weight of glucopyranose unit) was added dropwise over 40 min, and the reaction was continued for 105 min while maintaining the pH at 10.8 and temperature at 2° C. in the same manner as in Example 1. The amount of sodium hydroxide consumed was 47 mmol. Following the same precipitation operation as in Example 1, 10.6 g of yellow solid matter was obtained. As a result of the same dialysis-purification and evaluation as in Example 1, it was confirmed that the weight-average molecular weight calibrated by pullulan standard was 110,000, and the primary alcohol group at 6-position of monosaccharide residue was selectively oxidized into carboxyl group.

Then, the cross-linking reaction was performed as follows. The yellow solid matter (1.50 g) was dissolved in 15 mL of ion-exchanged water, to which 75 mg of ethylene glycol diglycidyl ether was added. The cross-linking reaction was conducted in the same manner as in Example 3 to obtain a solid matter. As a result of measuring the water absorption factor in the same manner as in Example 1, it was confirmed that the solid matter was not gelled and dissolved into both ion-exchanged water and physiological saline. Even when the addition amount of ethylene glycol diglycidyl ether was increased to 10% of the yellow solid matter, the solid matter was also dissolved in both ion-exchanged water and physiological saline.

### Comparative Example 2

The same oxidation reaction as in Comparative Example 1 was repeated using the same apparatus as used in Comparative Example 1 except that only the pH was changed to 10. Since the decrease in pH of the reaction solution due to formation of carboxyl group occurred so slowly, the reaction was not completed even after allowing the solution to stand at room temperature overnight The amount of sodium hydroxide consumed was 21.9 mmol. Then, following the same precipitation operation as in Comparative Example 1, 9.36 g of yellow solid matter was obtained. When tried to redissolve the yellow solid matter into water, water-insolubles were observed.

### Comparative Example 3

A granular high water-absorbing resin was sampled from a commercially available disposable diaper “OYASUMI-MAN” (pants-type) available from Uni-Charm Co., Ltd. The water absorption factor of the high water-absorbing resin measured in the same manner as in Example 1 was 480 for ion-exchanged water and 70 for physiological saline.

### EXAMPLE 8

Into 50 mL of a 48% NaOH aqueous solution place in a 200-mL round flask, was added 2.50 g of a powdery chitin (reagent) under ice-cooling. The flask was evacuated to 20 mmHg by a rotary evaporator under stirring, and then the stirring was continued for 45 min under ice-cooling until the chitin solution changed to a uniform viscous solution. After returning to ordinary pressure, 108 g of crushed ice was added to the flask, and the mixture was sufficiently stirred at room temperature for 5 h to promote a deacetylation reaction. The reaction solution was placed in a beaker, and concentrated sulfuric acid and diluted sulfuric acid were sequentially added to the reaction solution under ice-cooling while monitoring the pH by a pH meter to neutralize the reaction solution to a pH of 9. The viscosity of the solution was increased during the neutralization. The neutralized solution was added dropwise into one liter of ice-cooled acetone paced in a beaker while sufficiently stirring to precipitate a white solid matter, which was then separated by suction filtration, fully washed with an acetone/water (4/1 by volume) mixed solution, recovered, and vacuum-dried at 50° C. overnight, thereby obtaining 2.25 g of deacetylated chitin. The acetylation degree determined by the IR method was 0.70.

Into a 300-mL round bottom separable flask equipped with a stirrer, a thermometer, a pH meter, an oxidation-reduction potentiometer and feed pipes for sodium hypochlorite and sodium hydroxide, were charged 2.25 g of the deacetylated chitin and 200 mL of water. The mixture was suspended by stirring. The suspension was mixed with 100 mg of 2,2,6,6-tetramethylpiperidine-1-oxyl (TEMPO), and then 11.04 g of a 13.5% sodium hypochlorite solution (20 mmol) was added dropwise over 175 min while carefully preventing the increase of the pH and a rapid increase of the oxidation-reduction potential at the initial stage of the reaction. During the dropwise addition, a 2 N sodium hydroxide solution was also added dropwise under sufficient stirring to continue the reaction while controlling the pH at 9.0 and the temperature at 20° C. Since the pH was increased at the initial stage of the reaction, 90 mL of a 1 N hydrochloric acid was added in total.

After 220 min, the consumption of sodium hydroxide due to decrease of the pH was no longer caused, and the reaction was terminated. A slight amount of solids remained in the reaction solution and the amount of sodium hydroxide consumed was 6.1 mmol. The reaction solution was added dropwise into twice as much acetone as the reaction solution by volume to cause precipitation. The precipitate was separated by suction filtration, fully washed with an acetone/water (4/1 by volume) mixed solution, recovered and vacuum-dried at 50° C. overnight to obtain 2.49 g of oxidized deacetylated chitin.

Although slightly containing insolubles, the pullulan-calibrated weight-average molecular weight of solubles of the oxidized deacetylated chitin determined by the SEC analysis was 100,000. Separately, the solubles were dissolved in heavy water under heating to measure ¹³C-NMR spectra. The results showed that no peak attributable to methylene adjacent to unreacted primary alcohol group was detected, while two peaks attributable to the carbon of carboxyl group at 6-position and N-acetyl group were observed at around 180 ppm together with six different main peaks. Thus, it was confirmed that the main reaction product was constituted by repeating N-acetyl glucosamine units having their primary alcohol groups at 6-position oxidized to carboxyl groups.

### EXAMPLE 9

The same deacetylation procedure as in Example 8 was repeated except for using 2.50 g of a powdery chitin “CHA-1” available from Katakura Chikkarin Co., Ltd. to obtain 2.29 g of deacetylated chitin. The acetylation degree determined by the IR method was 0.72. Although the immersion time under reduced pressure was prolonged to 160 min, the chitin particles still remained undissolved to give no uniform liquid.

Then, the oxidation of the deacetylated chitin was conducted in the same manner as in Example 8 except that the amount of TEMPO was changed to 50 mg and 11.06 g of a 13.5% sodium hypochlorite solution (21 mmol) was added dropwise over 220 min. The reaction was continued for 330 min to obtain 2.50 g of oxidized deacetylated chitin. The amount of sodium hydroxide consumed was 5.2 mmol.

Although slightly containing insolubles, the pullulan-calibrated weight-average molecular weight of solubles of the oxidized deacetylated chitin determined by the SEC analysis was 700,000. Separately, the solubles were dissolved in heavy water under heating to measure ¹³C-NMR spectra. The results showed that the same main peaks as observed in Example 8 were observed together with a few sub-peaks.

### EXAMPLE 10

Into 150 mL of a 10% acetic acid solution placed in a 500-mL separable flask, was dissolved 2.00 g of powdery chitosan (reagent) under stirring. By adding 150 mL of methanol under stirring, was obtained a viscous solution, which was then added dropwise to 600 mL of ice-cooled pyridine placed in a beaker under sufficient stirring to cause gelatinization. The gel was milled under ice-cooling in a homogenizer and then washed with pyridine. The gel was placed into a separable flask into which 100 mL of pyridine was added. While stirring under ice-cooling, 12.6 g (124 mmol) of acetic anhydride was added dropwise to the mixture, and the stirring was further continued for 18 h at room temperature. The gel/pyridine mixture was added dropwise into 700 mL of ice-cooled acetone in a beaker under sufficient stirring, thereby precipitating a white solid matter. The white solid matter was separated by suction filtration, fully washed with acetone, recovered and vacuum-dried at 50° C. overnight, thereby obtaining a solid matter. Since the ester absorption attributable to O-acetyl group was observed around 1750 cm⁻¹ in the IR measurement, the solid matter was added to a solution of 0.56 g (10 mmol) of potassium hydroxide in 100 mL of methanol to conduct hydrolysis of the ester under stirring at room temperature for 6 h. The resulting precipitates were separated by suction filtration, fully washed with methanol, recovered and vacuum-dried at 50° C. overnight to obtain 1.65 g of partially-acetylated chitosan. The acetylation degree determined by the IR method was 0.75.

Then, the oxidation of the partially-acetylated chitosan was conducted in the same manner as in Example 8 except that the amount of TEMPO was changed to 50 mg and 8.50 g of a 13.5% sodium hypochlorite solution (15.4 mmol) was added dropwise over 130 min. The reaction was continued for 180 min to obtain 1.77 g of oxidized partially-acetylated chitosan. The amount of sodium hydroxide consumed was 3.8 mmol.

Although slightly containing insolubles, the pullulan-calibrated weight-average molecular weight of solubles of the oxidized partially-acetylated chitosan determined by the SEC analysis was 500,000. Separately, the solubles were dissolved in heavy water under heating to measure ¹³C-NMR spectra. The results showed that the same main peaks as observed in Example 8 were observed.

### EXAMPLE 11

The deacetylated chitin produced in the same manner as in Example 9 was oxidized in the same manner as in Example 8 except that 160 mg (1.56 mmol) of sodium bromide was further added, the amount of TEMPO was changed to 50 mg, and 11.60 g of a 13.5% sodium hypochlorite solution (21 mmol) was added dropwise over 120 min. The reaction was continued for 170 min to obtain 2.49 g of oxidized deacetylated chitin. The amount of sodium hydroxide consumed was 6.4 mmol.

Although slightly containing insolubles, the pullulan-calibrated weight-average molecular weight of solubles of the oxidized deacetylated chitin determined by the SEC analysis was 500,000. Separately, the solubles were dissolved in heavy water under heating to measure ¹³C-NMR spectra. The results showed that the same main peaks as observed in Example 8 were observed together with a few sub-peaks.

### EXAMPLE 12

The moisture absorption/retention of the oxides obtained in Examples 8 to 12 was compared with those of sodium hyaluronate produced by microorganism (genuine chemical reagent). The changes with time of the moisture absorption factor and the residual water content are shown in Tables 1 and 2. From the results, it was confirmed that the oxides of Examples 8 to 12 exhibited the moisture absorption/retention property comparable to those of the sodium hyaluronate.

TABLE 1
Change of moisture absorption factor with time
at a relative humidity of 81%

Time Elapsed

| | 3 h | 9 h | 24 h | 48 h |
|---|---|---|---|---|
| Example 1 | 5.0 | 14 | 28 | 35 |
| Example 2 | 6.2 | 16 | 29 | 36 |
| Example 3 | 8.2 | 18 | 30 | 38 |
| Example 4 | 7.9 | 17 | 29 | 39 |
| Sodium hyaluronate | 7.8 | 15 | 28 | 35 |

TABLE 2
Change of residual water content with time
in the presence of silica gel

Time Elapsed

| | 2 h | 8 h | 24 h | 48 h |
|---|---|---|---|---|
| Example 1 | 95 | 82 | 54 | 36 |
| Example 2 | 97 | 94 | 60 | 43 |
| Example 3 | 102 | 100 | 66 | 49 |
| Example 4 | 96 | 87 | 56 | 35 |
| Sodium hyaluronate | 104 | 103 | 68 | 52 |

### Comparative Example 4

Into a 300-mL round bottom separable flask equipped with a stirrer, a thermometer, a pH meter, an oxidation-reduction potentiometer and feed pipes for sodium hypochlorite and sodium hydroxide, were charged 2.25 g of a chitin (reagent) and 200 mL of water. The mixture was suspended by stirring. After adding 100 mg of TEMPO, the oxidation of chitin was attempted by adding dropwise 11.04 g of a 13.5% sodium hypochlorite solution (20 mmol) in the same manner as in Example 8. However, the oxidation reaction does not occur and the oxidation-reduction potential was increased. Alternatively, 50% amount (5.52 g) of the sodium hypochlorite to be added was added dropwise over 170 min while adjusting the pH by adding a 1N hydrochloric acid. However, no sodium hydroxide was consumed. The suspension was allowed to stand overnight and then treated in the same manner as in Example 8 to obtain 2.03 g of a solid matter, which was however water-insoluble.

### Comparative Example 5

The oxidation of chitin was attempted in the same manner as in Comparative Example 4 except that 515 mg (5.0 mmol) of sodium bromide was further added, the pH was changed to 10.8, and the sodium hypochlorite solution was added dropwise over 130 min. The reaction was continued for 170 min to obtain 2.21 of a solid matter. The amount of sodium hydroxide consumed was 8.4 mmol.

Although slightly containing insolubles, the pullulan-calibrated weight-average molecular weight of solubles of the solid matter determined by the SEC analysis was 4,500. Separately, the solubles were dissolved in heavy water under heating to measure ¹³C-NMR spectra. The results showed that the same main peaks as observed in Example 8 were observed.

### Comparative Example 6

Into 210 mL of a 10% acetic acid solution placed in a 300-mL round bottom separable flask equipped with a stirrer, a thermometer, a pH meter, an oxidation-reduction potentiometer and feed pipes for sodium hypochlorite and sodium hydroxide, was dissolved 2.10 g of powdery chitosan (reagent) by stirring. After adding 100 mg of TEMPO, a 2 N NaOH solution was added to adjust the pH to 9. Although a film-like gel was precipitated, 15.84 g of a 13.5% sodium hypochlorite solution (29 mmol) was added dropwise over 260 minutes and the reaction was conducted for 270 minutes. The amount of sodium hydroxide consumed was 7.4 mmol exclusive of those consumed by neutralization.

Although slightly containing insolubles, the pullulan-calibrated weight-average molecular weight of solubles of the product determined by the SEC analysis was 200. Separately, the solubles were dissolved in heavy water under heating to measure ¹³C-NMR spectra. The results showed that a peak attributable to methylene adjacent to primary alcohol group was observed around 63 ppm, while no peak attributable to the carbon of carboxyl group was observed. This showed that the oxidation reaction did not occur.

In accordance with the present invention, there is obtained an oxidized polysaccharide derivative which is improved in absorption of physiological saline. The oxidized polysaccharide derivative is suitably used as a scale-adhesion inhibitor, a dispersing agent, a seizing agent, a concrete filler, a detergent builder, a polymer coagulant, various water absorbents especially an absorbent having an excellent salt resistance.

The present invention further provides a high molecular-weight oxidized polyglycosamine derivative (analogue of mucopolysaccharides) by introducing a sufficient number of carboxyl groups into a polyglycosamine without causing the cleavage of molecular chains. The oxidized polyglycosamine derivative has properties comparable to those of naturally occurring mucopolysaccharides. The oxidized polyglycosamine derivative provides a more inexpensive analogue of various naturally occurring mucopolysaccharides or raw materials thereof, and are suitably used as raw materials of cosmetics or medicines because of good water-absorbing property and water-retention property.

What is claimed is:

1. A process for producing an oxidized polysaccharide derivative, comprising:
pretreating a polysaccharide to enhance a water solubility thereof; and
oxidizing the pretreated polysaccharide with hypochlorous acid or a salt thereof in the presence of a nitroxyl compound.

2. The process according to claim 1, wherein the nitroxyl compound is a di-tert-alkylnitroxyl compound.

3. The process according to claim 1, wherein the pretreatment for enhancing the water solubility is carried out by gelatinizing an α-bonded polysaccharide.

4. The process according to claim 1, wherein the pretreatment for enhancing the water solubility is carried out by mercerizing a β-bonded polysaccharide.

5. The process according to claim 1, wherein the oxidization is carried out at a pH of 7 to 11.

6. The process according to claim 1, wherein the oxidization is carried out in the presence of bromine, a bromide, iodine or an iodide in an amount of less than 40 mol % of a glucopyranose and/or glucofuranose unit constituting the polysaccharide.

7. The process according to claim 1, wherein the oxidization is carried out in the absence of bromine, a bromide, iodine or an iodide.

8. The process according to claim 1, wherein the polysaccharide is selected from the group consisting of starch, amylose, amylopectin, pectin, protopectin, pectic acid, cellulose and derivatives thereof.

9. A high water-absorbing resin comprising an oxidized polysaccharide derivative as defined in claim 1.

10. The high water-absorbing resin according to claim 9, wherein the weight-average molecular weight of the oxidized polysaccharide derivative is 200,000 or more.

11. A process for producing an oxidized polyglycosamine derivative, comprising:
pretreating a polyglycosamine to enhance a water solubility thereof; and
oxidizing the pretreated polyglycosamine with hypochlorous acid or a salt thereof in the presence of a nitroxyl compound.

12. The process according to claim 11, wherein the nitroxyl compound is a di-tert-alkylnitroxyl compound.

13. The process according to claim 11, wherein the polyglycosamine is pretreated by controlling an acetylation degree of an amino group of the polyglycosamine to enhance the water solubility.

14. The process according to claim 13, wherein the acetylation degree of the polyglycosamine is 0.3 or higher.

15. The process according to claim 1, wherein the polyglycosamine is selected from the group consisting of chitin, chitosan, polygalactosamine, hyaluronic acid, chondroitin and chondroitin sulfate, and derivatives thereof.

16. The process according to claim 1, wherein the oxidization of the pretreated polyglycosamine is carried out at a pH of 7 to 11.

17. The process according to claim 1, wherein the oxidization is carried out in the presence of bromine, a bromide, iodine or an iodide in an amount of less than 40 mol % of a glucopyranose and/or glucofuranose unit constituting the polyglycosamine.

18. The process according to claim 1, wherein the oxidization is carried out in the absence of bromine, a bromide, iodine or an iodide.

19. An oxidized polyglycosamine derivative having a molecular weight of 100,000 or more, in which 40% or more of primary alcohol groups of repeating units are oxidized into carboxyl groups.
